(19) United States
(12) Patent Application Publication
(10) Pub. No.: US 2026/0048587 A1
(43) Pub. Date: Feb. 19, 2026

(54) LIQUID EJECTION DEVICE AND LIQUID EJECTION HEAD

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP); AYAKO IWASAKI, Kanagawa (JP)

(21) Appl. No.: 19/291,980

(22) Filed: Aug. 6, 2025

(30) Foreign Application Priority Data
Aug. 14, 2024 (JP) 2024-135219

(51) Int. Cl. B41J 2/045; B41J 2/14

(52) U.S. Cl. CPC B41J 2/04596; B41J 2/04563; B41J 2/04571; B41J 2/04573; B41J 2/0458; B41J 2/14056; B41J 2/14088; B41J 2/14153

(57) ABSTRACT

A liquid ejection device includes: a channel forming portion including an ejection opening through which a liquid is ejected, a pressure chamber communicating with the ejection opening, and an individual channel communicating with the pressure chamber; a first energy generation element provided at a position corresponding to the pressure chamber of the channel forming portion, and generates energy for ejecting the liquid through the ejection opening; a second energy generation element provided at a position corresponding to the individual channel of the channel forming portion, and generates energy for passing the liquid through the individual channel; a temperature detection portion configured to detect a temperature, and is disposed at a position corresponding to the first energy generation element or the second energy generation element; and a control portion configured to control driving of the second energy generation element based on a detection result of the temperature detection portion.

### BACKGROUND

### Field of the Technology

The present disclosure relates to a liquid ejection device and a liquid ejection head provided to the liquid ejection device.

### Description of the Related Art

In a liquid ejection head for ejecting a liquid such as ink, a volatile component contained in the liquid may evaporate and increase the viscosity of the liquid around the ejection opening. Such an increase in the liquid viscosity may affect the ejection speed and landing accuracy of the ejected droplets. One of known measures for suppressing such an increase in liquid viscosity is a circulation driving operation, in which an extremely small circulating flow is generated inside an individual channel including the ejection opening.

WO 2016/068988 discloses a configuration provided with a fluid circulating element and being capable of executing a circulation driving sequence for driving the fluid circulating element to cause the fluid to circulate intermittently.

If the conditions and the number of times for causing the fluid to circulate are set to resolve the increase in viscosity reliably, while taking variations and the like into consideration, there may be cases that the amount of circulation is set excessively. Excessive circulation of liquid through the liquid ejection head may lead to generation of heat or liquid thickening, as a result of driving the liquid to circulate.

### SUMMARY

The present disclosure is directed to provide a liquid ejection device capable of suppressing excessive circulation of the liquid.

According to some embodiments, a liquid ejection device of the present disclosure is characterized by features including:
a channel forming portion including an ejection opening through which a liquid is ejected, a pressure chamber communicating with the ejection opening, and an individual channel communicating with the pressure chamber;
a first energy generation element provided at a position corresponding to the pressure chamber of the channel forming portion, and generates energy for ejecting the liquid through the ejection opening;
a second energy generation element provided at a position corresponding to the individual channel of the channel forming portion, and generates energy for passing the liquid through the individual channel;
a temperature detection portion configured to detect a temperature, and is disposed at a position corresponding to the first energy generation element or the second energy generation element; and
a control portion configured to control driving of the second energy generation element based on a detection result of the temperature detection portion.

According to the present disclosure, a liquid ejection device that can suppress excessive circulation of the liquid can be provided.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic perspective views illustrating a general configuration of a liquid ejection device according to a first embodiment;

FIG. 2 is a control block diagram illustrating a control system of the liquid ejection device according to the first embodiment;

FIGS. 3A to 3D are schematics for explaining a liquid ejection head according to the first embodiment;

FIGS. 4A to 4C are schematic diagrams for explaining a relevant portion of the liquid ejection head according to the first embodiment;

FIG. 5 is a flowchart of a circulation amount control according to the first embodiment;

FIGS. 6A to 6F are charts for explaining a driving sequence according to the first embodiment;

FIG. 7 is a schematic diagram for explaining a relevant portion of a liquid ejection head according to a second embodiment;

FIG. 8 is a flowchart of circulation amount control according to the second embodiment;

FIGS. 9A and 9B are schematics for explaining a driving sequence according to the second embodiment;

FIGS. 10A to 10C are schematic diagrams for explaining a relevant portion of a liquid ejection head according to a third embodiment;

FIG. 11 is a schematic diagram for explaining a relevant portion of a liquid ejection head according to a fourth embodiment;

FIGS. 12A and 12B are schematic diagrams for explaining a relevant portion of a liquid ejection head according to a fifth embodiment;

FIG. 13 is a schematic diagram for explaining a relevant portion of a liquid ejection head according to a sixth embodiment; and

FIG. 14 is a flowchart of circulation amount control according to a seventh embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

The present disclosure relates to a recording element unit provided to a liquid ejection head for carrying out recording or the like by ejecting liquid onto a recording medium. The present disclosure can be suitably applied to, for example, a recording element unit in an inkjet head provided to an inkjet printer of an inkjet recording system that carries out recording by forming a bubble in a liquid such as ink, using thermal energy. However, applications of the recording element unit according to the present disclosure are not limited thereto, and the recording element unit is also applicable as recording element units in various types of liquid ejection heads that eject a liquid using thermal energy.

A liquid ejection head and a liquid ejection device provided with a liquid ejection head according to some embodiments of the present disclosure will now be explained with reference to drawings. In the following description of the embodiments, a specific configuration of a liquid ejection head for ejecting ink will be explained, but the present disclosure is not limited thereto. The liquid ejection head according to the present disclosure can be applied to printers, copiers, facsimiles with communication systems, word processors with printer portions, and industrial recording devices combined with various processing devices. For example, the liquid ejection head may also be used for applications such as bio-chip fabrications and electronic circuit printing.

### First Embodiment

A liquid ejection device 50 according to a first embodiment of the present disclosure will now be explained. The liquid ejection device 50 is an inkjet recording device that uses an inkjet recording method, and includes a liquid ejection head 1 capable of ejecting ink as a liquid.

### Liquid Ejection Device

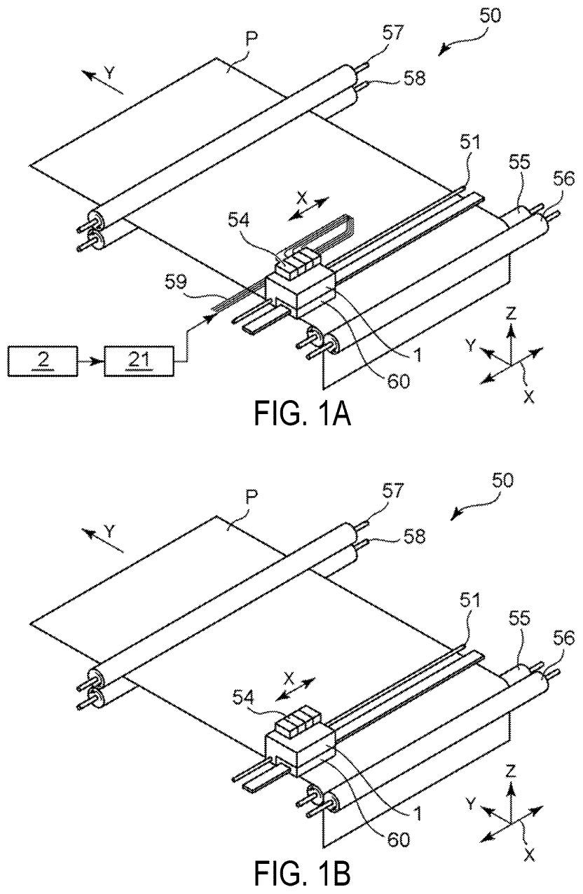

A general configuration of the liquid ejection device 50 according to the first embodiment will now be explained. FIGS. 1A and 1B are perspective views illustrating a configuration of a recording portion of the liquid ejection device 50. The liquid ejection device 50 is a serial liquid ejection device, in which an image is recorded by causing a liquid ejection head 1 to scan in directions intersecting with the conveying direction of a recording medium P while ejecting the liquid onto the recording medium P.

The present disclosure is not limited to a serial liquid ejection device, and is also applicable to a page-wide liquid ejection device that carries out image recording by ejecting a liquid, using a line head (page-wide head) that is long in the page-width direction of the recording medium.

The liquid ejection head 1 can eject four inks of black (K), cyan (C), magenta (M), and yellow (Y), respectively, and can record full-color images using these inks. The inks the liquid ejection head can eject is not limited to these four inks. The present disclosure is also applicable to a liquid ejection head for ejecting other kinds of ink. In other words, there is no limitation to the type and the number of inks ejected from the liquid ejection head.

In the following description, the scanning direction (moving direction) of the liquid ejection head 1 will be referred to as an X direction; the direction in which a recording medium P is conveyed by the recording portion will be referred to as a Y direction; and the vertical direction will be referred to as a Z direction. Each of the X, Y and Z directions intersects (in this example, orthogonally) with the others. Sometimes the direction in which the liquid ejection head 1 is scanned (moved) will be referred to as a main scanning direction, and the direction in which the recording medium P is conveyed will be referred to as a sub-scanning direction.

In the serial liquid ejection device 50, the liquid ejection head 1 is mounted on a carriage 60. The carriage 60 moves back and forth in the main scanning direction (X direction) along a guide shaft 51. The recording medium P is conveyed in the sub-scanning direction (Y direction) intersecting (in this example, orthogonally) with the main scanning direction, by conveying rollers 55, 56, 57, 58 included in a conveying portion (conveyor).

FIG. 1A is a perspective view illustrating an exemplary configuration in which a main ink tank 2 as a liquid reservoir portion is provided to a main body of the liquid ejection device 50 (external of the liquid ejection head 1), and a sub-ink tank 54 is provided to the liquid ejection head 1. The liquid (ink) stored in the ink tank 2 is supplied, with a driving force of an external pump 21, to the sub-ink tank 54 inside the liquid ejection head 1, through an ink supply tube (liquid passage) 59, for example. In other words, in the example illustrated in FIG. 1A, the liquid storage portion where the ink is stored is provided to each of the main body and the liquid ejection head 1 of the liquid ejection device 50.

FIG. 1B is a perspective view illustrating an exemplary configuration not provided with the main ink tank 2 but provided with an ink tank 54 immediately above the liquid ejection head 1. The liquid ejection head 1 may be integrated with the ink tank 54, and configured to be removable from the carriage 60. The liquid ejection head 1 may also be integrated with the carriage 60, with only the ink tank 54 configured removable. The configuration illustrated in FIG. 1A will be used as a representative example in the following description.

The liquid ejection head 1 includes an individual ejection unit, which will be described later. The individual ejection unit, a specific configuration of which will be described later, is a recording element unit including an ejection opening through which a liquid is ejected, a pressure chamber communicating with the ejection opening, and an individual channel communicating with the pressure chamber. The individual ejection unit includes a first energy generation element (ejection energy generation element) that is provided at a position corresponding to the pressure chamber, and generates the energy for causing the ejection opening to eject the liquid, and a second energy generation element (fluid energy generation element) that is provided at a position corresponding to the individual channel. The liquid ejection head 1 has a plurality of individual ejection units, and has supply channels for supplying the liquid into the individual channels included in the respective individual ejection units.

While the liquid ejection head 1 is in use, ejections of ink may become unstable due to factors such as evaporation of a volatile component such as moisture in the ejection opening, and aggregation of the solid near the ejection opening. In order to prevent such instability, various types of devising have been come up with. For example, the liquid ejection device 50 may be provided with a cap member (not illustrated) that can cover an ejection opening surface, where the ejection opening is provided, on the liquid ejection head 1, at a position separated from the conveying path of the recording medium P in the X direction. The cap member is used for preventing the ejection opening from drying and protecting the ejection opening, by covering the ejection opening surface of the liquid ejection head 1 while the recording operation is not being performed.

It is also possible to provide an ink suction mechanism (not illustrated) to the liquid ejection device 50. With such an ink suction mechanism provided, a cap member is used in the operation of suctioning ink from the ejection opening, for example. By performing this ink suctioning operation, it is possible to refresh the ink near the ejection opening and to maintain the image quality of images achieved.

Furthermore, it is also possible to discard the thickened ink by executing what is called preliminary ejection (pre-ejection) while the recording operation is not being performed. Such preliminary ejection may be performed during the recording operation, too, by ejecting an unnoticeable amount of ink to the recording medium, at a position unnoticeable in terms of the image quality (paper sheet preliminary ejection/in-page preliminary ejection). Although these methods contribute greatly to the improvement of image quality, there is a demand for reducing the amount of waste ink as much as possible, because some of the ink is discarded in refreshing the ejection opening.

In relation to this demand, by providing a second energy generation element (fluid energy generation element) in the individual channel and circulating the ink through the channel, it is possible to inhibit drying of the ejection opening and thickening of the ink near the ejection opening, while suppressing the amount of waste ink. More specifically, it is possible to minimize the number of times the preliminary ejections and suctioning recoveries are executed. Furthermore, by reducing the number of times the preliminary ejection or the like are performed, the throughput and yield can be improved, too.

The second energy generation element (fluid energy generation element) does not need to be provided to every individual ejection unit included the liquid ejection head. As long as the second energy generation elements are provided to some of the individual ejection units, the advantageous effects described above can be achieved, compared with a configuration not having the second energy generation elements.

It is also possible for the liquid ejection head 1 to have a configuration in which a portion corresponding to each of the four inks is provided with the second energy generation elements, or a configuration in which only a portion corresponding to one of the inks is provided with the second energy generation elements. That is, the liquid ejection head may be configured to circulate at least one ink, without circulating all of the four inks.

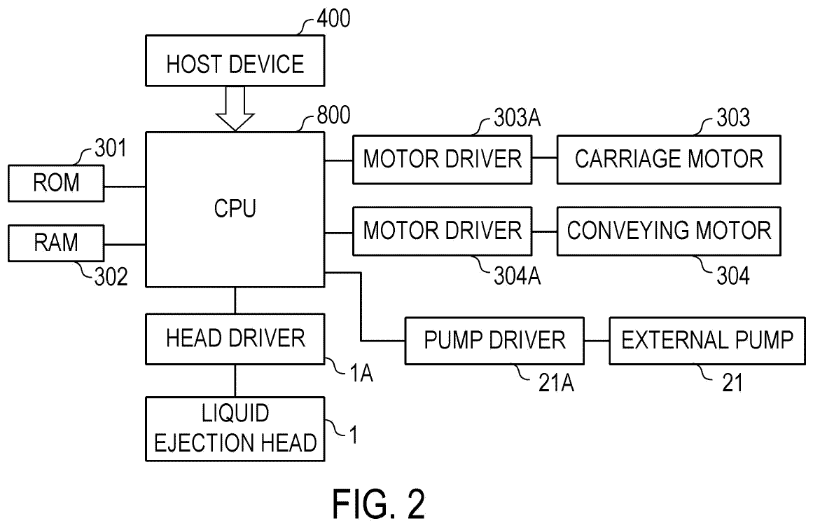

FIG. 2 is a block diagram illustrating a control system of the liquid ejection device 50. A CPU 800 is a control portion for controlling the operation of the portions of the liquid ejection device 50, on the basis of a program such as a processing procedure stored in a ROM 301. A RAM 302 is used as a working area or the like, when the CPU 800 executes processing. The CPU 800 receives image data from a host device 400 external of the liquid ejection device 50, and controls the driving of the ejection elements provided to the liquid ejection head 1, by controlling a head driver 1A on the basis of image data.

The CPU 800 also controls drivers of various types of actuators provided in the liquid ejection device 50. For example, the CPU 800 controls a motor driver 303A of a carriage motor 303 for moving the carriage 60, a motor driver 304A of a conveying motor 304 for conveying the recording medium P, and a pump driver 21A of the external pump 21. Although FIG. 2 illustrates a configuration in which the image data is received from the host device 400, it is also possible to execute processing on the liquid ejection device 50 without using any data from the host device 400.

### Liquid Ejection Head

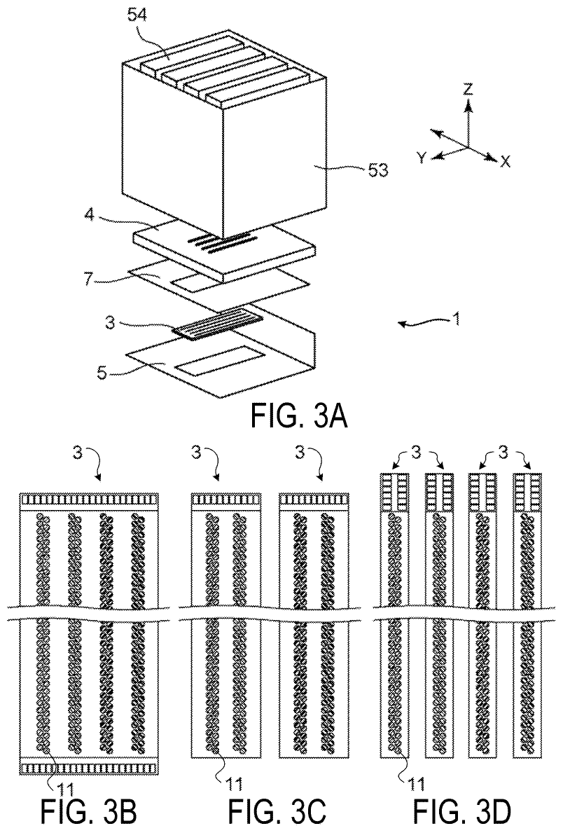

An exemplary configuration of the liquid ejection head 1 will now be explained. FIGS. 3A to 3D are schematics for explaining the liquid ejection head 1 according to the first embodiment. FIG. 3A is an exploded perspective view of the liquid ejection head 1.

The liquid ejection head 1 includes four sub-ink tanks 54 for temporarily storing the inks in the head, and a liquid ejection chip 3 for causing the inks supplied from the sub-ink tanks 54 to be ejected onto a recording medium P.

The liquid ejection head 1 also includes a first support member 4, a second support member 7, and an electric wiring member (electric wiring tape) 5. To one surface of the first support member 4, the liquid ejection chip 3 is connected, and the ink tanks 54 are connected to the other surface. The first support member 4 has channels passing therethrough from the one surface to the other surface, and the first support member 4 passes the ink supplied from the ink tank 54 to the liquid ejection chip 3, while supporting the liquid ejection chip 3.

The second support member 7 is connected to the first support member 4 on the surface where the liquid ejection chip 3 is connected. The second support member 7 has an opening through which the liquid ejection chip 3 can pass, and the second support member 7 is connected to the first support member 4 with the liquid ejection chip 3 positioned inside the opening. The second support member 7 also serves to support the electric wiring member 5.

The electric wiring member 5 is electrically connected to the liquid ejection chip 3, and sends ejection signals for ejecting the ink, received from the main body of the liquid ejection device 50 or the like, to the liquid ejection chip 3.

The liquid ejection head 1 according to the first embodiment is fixed to and supported by the carriage 60 of the liquid ejection device 50, via an alignment unit and electrical contacts (not illustrated) provided to the carriage 60. The liquid ejection head 1 carries out recording on the recording medium P by moving with the carriage 60 in the main scanning direction (X direction) while ejecting ink.

The ink supply tube 59 is provided to the external pump 21 that is connected to the main ink tank 2, which serves as an ink source. To the tip end of the ink supply tube 59, a liquid connector (not illustrated) is provided. When the liquid ejection head 1 is mounted on the liquid ejection device 50, the liquid connector provided at the tip end of the ink supply tube 59 is liquid-tightly connected to a liquid connector insertion port, which is a liquid inlet provided to a head housing of the liquid ejection head 1. In this manner, an ink supply channel extending from the ink tank 2 to the liquid ejection head 1 via the external pump 21 is formed. In the first embodiment, because four inks are used, four sets of the ink tank 2, the external pump 21, the ink supply tube 59, and the sub-ink tank 54 are provided in total, in a manner corresponding to the respective inks. The liquid ejection device 50 is also provided with four independent ink supply channels corresponding to the respective inks.

As described above, the liquid ejection device 50 is provided with an ink supply system for supplying ink from the ink tank 2 external of the liquid ejection head 1. Note that the liquid ejection device 50 is not provided with an ink recovery system for recovering the ink from the liquid ejection head 1 into the ink tank 2. Therefore, despite being provided with a liquid connector insertion port for connecting the ink supply tube 59 of the ink tank 2, the liquid ejection head 1 is not provided with a connector insertion port for connecting a tube for recovering the ink from the liquid ejection head 1 into the ink tank 2. The liquid connector insertion ports are provided correspondingly to the respective inks.

FIGS. 3B, 3C, and 3D are schematics illustrating exemplary configurations of the liquid ejection chip 3 included in the liquid ejection head 1. FIG. 3B illustrates an exemplary configuration including one chip correspondingly to four ink colors. FIG. 3C illustrates an exemplary configuration including one chip correspondingly to two ink colors. FIG. 3D illustrates an exemplary configuration including one chip correspondingly to one ink color. Each of the liquid ejection chips is provided with ejection openings 11, and pads to be used for electrical implementation. The chip configuration illustrated in FIG. 3A has the configuration illustrated in FIG. 3B.

FIG. 3B illustrates an example in which one liquid ejection chip 3 is provided correspondingly to four ink colors, and the liquid ejection head 1 therefore has one liquid ejection chip 3. The four colors are, for example, black, cyan, magenta, and yellow. The liquid ejection chip 3 is provided with ejection opening rows each including a plurality of ejection openings 11 that are arranged at equal intervals along the Y direction, with the ejection opening rows corresponding to the respective colors. In this example, two ejection opening rows are provided correspondingly to each of the colors, in a manner offset from each other in the X direction. It is also possible to provide one ejection opening row, for each of the colors, instead of two ejection opening rows. It is also possible to provide two ejection opening rows only for the black color so that five ejection opening rows in total are provided for the four colors.

FIG. 3C illustrates an example in which one liquid ejection chip 3 is provided correspondingly to two ink colors, and therefore the liquid ejection head 1 has two liquid ejection chips 3. As possible implementations of the two chips on the liquid ejection head 1, two chips may be implemented on one liquid ejection head 1, or two heads each having one chip implemented thereon may be prepared.

FIG. 3D illustrates an example in which one liquid ejection chip 3 is provided correspondingly to one ink color, and therefore the liquid ejection head 1 has four liquid ejection chips 3. In this example, four chips may be implemented on one liquid ejection head 1, or four heads each having one chip implemented thereon may be prepared, in the same manner as in the example in FIG. 3C.

Furthermore, in the configurations in which a plurality of chips are used, as in the examples illustrated in FIGS. 3C and 3D, all of the chips do not need to have the same chip length. As to the number of colors corresponding to one chip, various other combinations are still possible, and the same is applicable even when the total number of colors is more than four.

### Liquid Ejection Chip

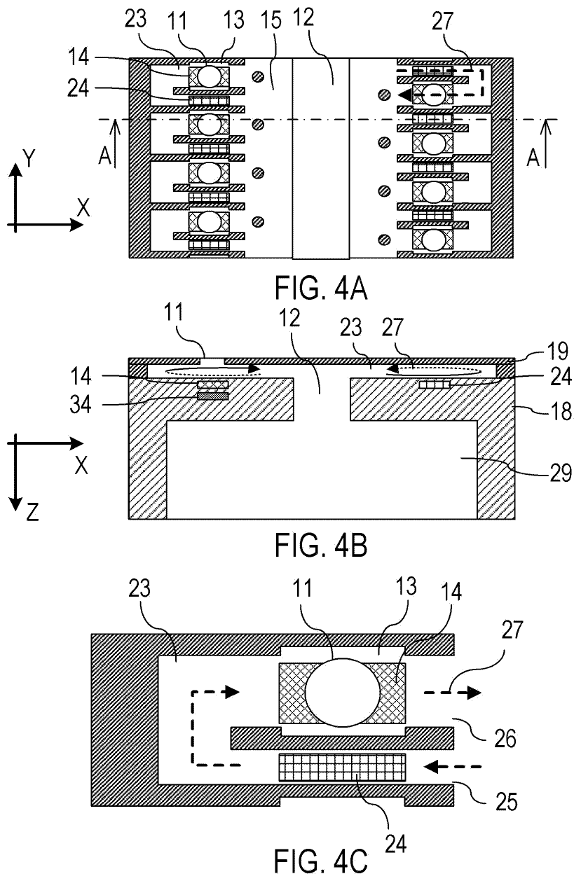

The configuration of the liquid ejection chip 3 will now be explained more in detail. FIGS. 4A to 4C are schematics for explaining the channel configuration of the liquid ejection chip 3 according to the first embodiment. FIG. 4A is a schematic for explaining a configuration near the ejection openings 11 on the liquid ejection chip 3, and is a schematic diagram illustrating a positional relationship among main components, in a view of the liquid ejection chip 3 in the Z direction. The Z direction is substantially parallel with the direction in which the liquid is ejected from the ejection opening 11. FIG. 4B is a cross-sectional view taken along A-A in FIG. 4A. FIG. 4C is a schematic diagram illustrating an enlargement of a portion corresponding to an individual channel in FIG. 4A.

The liquid ejection chip 3 includes a substrate 18 having the ejection openings 11, and an orifice plate 19 that is connected to the substrate 18 and internal of which is provided with a channel, and is a channel forming portion internal of which has a channel through which the ink flows. In FIG. 4A, to indicate the positional relationship of the main components, a first energy generation element 14 and a second energy generation element 24 are given the same respective hatchings as those in FIG. 4B, and the ejection openings 11 are indicated by solid lines. The ink supplied from the ink tank 54 passes through the channel formed inside the substrate 18, and is ejected through the ejection openings 11.

The liquid ejection chip 3 includes the ejection openings 11, the pressure chamber 13 communicating with the ejection opening 11, and the individual channel 23 communicating with the pressure chamber 13. The orifice plate 19 is a plate member where a plurality of ejection openings 11 are formed, and is connected to the substrate 18. The pressure chamber 13 and the individual channel 23 are provided correspondingly to each of the ejection openings 11, and the orifice plate 19 and the substrate 18 form a portion of the inner wall thereof. The individual channel 23 communicates with the pressure chamber 13 on both sides in the X direction. In other words, the pressure chamber 13 can be considered as a portion of the individual channel 23. The individual channel 23 according to the first embodiment has a U shape, in a view in the Z direction, as illustrated in FIG. 4C. Hereinafter, such a shape of the channel will be referred to as a U shape.

The first energy generation element 14 is provided to the substrate 18, at a position overlapping with the ejection opening 11 and the pressure chamber 13 in a view along the Z direction. The first energy generation element 14 is an element for generating energy for causing the ejection opening 11 to eject ink, and a thermoelectric transducer may be used, for example.

To the substrate 18, the second energy generation element 24 is also provided, at a position corresponding to the individual channel 23, specifically, at a position different from the first energy generation element 14 and overlapping with the individual channel 23, in a view along the Z direction. The second energy generation element 24 is an element that generates energy for causing the ink to circulate through the individual channels 23, and may have the same configuration as that of the first energy generation element 14. In the first embodiment, the first energy generation element 14 and the second energy generation element 24 are disposed adjacently to each other in the Y direction, with a partitioning wall therebetween. That is, the first energy generation element 14 is provided correspondingly to one linear portion of the U shape of the individual channel 23, and the second energy generation element 24 is provided correspondingly to the other linear part.

The substrate 18 is also provided with a common channel 15 communicating with the plurality of individual channels 23, and a supply groove 12 communicating with the common channel 15, as channels through which ink flows. Ink is supplied from the supply grooves 12 formed in the substrate 18, through the common channel 15, into the individual channels 23. The energy generated by the second energy generation element 24 causes the ink to circulate along the individual channel 23 in a direction traveling from the second energy generation element 24 to the first energy generation element 14. FIGS. 4A to 4C illustrate a circulating flow 27, which is a flow of ink circulating through the individual channel 23, using arrows. That is, the individual channel 23 is a circulation channel allowing the ink to circulate, and the second energy generation element 24 generates energy for causing the ink to circulate through the individual channel 23.

Provided in the first embodiment are two ejection opening rows each including a plurality of ejection openings 11 that are aligned in the Y direction. The supply groove 12 is provided between the two ejection opening rows in the X direction. The supply groove 12 is a groove that is long in the Y direction, and forms a channel for supplying ink supplied from the ink tank 54 through the first support member 4, to the individual channel 23.

The substrate 18 also has a common liquid chamber 29 communicating with the supply groove 12. The ink supplied from the ink tank 54 flows into the common liquid chamber 29. In other words, the ink supplied from the ink tank 54 flows through the common liquid chamber 29 and the supply groove 12 to reach the individual channel 23.

A circulation system will now be explained with reference to FIG. 4C. Among the two end portions of the individual channel 23, one end portion into which the ink flows, when the circulating flow 27 is generated, will be referred to as an inlet 25, and the other end portion from which the ink flows out will be referred to as an outlet 26. The pressure chamber 13 and the first energy generation element 14 are located on the side near the outlet 26, and the second energy generation element 24 is positioned on the side near the inlet 25. In the U-shaped individual channel 23, the outlet 26 and the inlet 25 are adjacent to each other in the Y direction. In the following description of the ink (liquid) flow and circulation amount control, the pressure chamber 13 will be considered as a portion of the individual channel 23.

At the ejection opening 11, the water content (volatile component) of the ink evaporates, the viscosity of the ink increases, and the ink becomes thickened ink. By causing the second energy generation element 24 to generate a circulating flow 27, the thickened ink is caused to flow out through the outlet 26. In this manner, by replacing the thickened ink at the ejection opening 11, the effect of resolving the thickening of ink can be achieved.

As the ink is circulated, the ink goes out of the individual channel 23 through the outlet 26, and goes into the individual channel 23 through the inlet 25, at the same time. Therefore, when the outlet 26 and the inlet 25 are positioned near each other, e.g., as in the U-shaped individual channel 23, the thickened ink, having the water content evaporated at the ejection opening portion, may re-enter the individual channel 23. Therefore, excessive circulation will lead to the rise of a new challenge that ink thickening proceeds in each of the individual channels 23. To suppress the progress of ink thickening in each of the individual channels 23, the ink thickening being associated with microcirculation, it is important to control the amount of ink to be circulated, so as not to circulate any ink more than necessary.

In the first embodiment, thermoelectric transducers are used as the first energy generation element 14 and the second energy generation element 24. It is also possible to use another type of element such as a piezoelectric element as the second energy generation element 24.

The substrate 18 includes a temperature detection element 34 as a temperature detection portion (temperature detection portion) for detecting a temperature of at least one of the individual channel 23 and the pressure chamber 13. In the first embodiment, the temperature detection element 34 is disposed at a position corresponding to the pressure chamber 13, specifically, at a position overlapping with the ejection opening 11 and the first energy generation element 14 in a view along the Z direction. As illustrated in FIG. 4B, the temperature detection element 34 is positioned immediately below the first energy generation element 14, that is, on the side farther away from the individual channel 23 and the ejection opening 11, than the first energy generation element 14.

With the first energy generation element 14, the detected temperature goes through a temporal change increasing as a result of application of the driving voltage pulse, reaching the peak temperature, and then decreasing, with a characterizing point at which the temperature suddenly drops in the process of decreasing. This characterizing point is resultant of a significant change in the thermal conductivity due to gas being replaced by liquid, at the position corresponding to the first energy generation element 14, in a process in which a liquid bubble collapses, the liquid bubble being formed by being heated by the first energy generation element 14.

As the ink in each of the individual channels 23 becomes more viscous by being affected by the thickened ink, the viscous resistance also increases, and the time for the ink bubble to collapse becomes extended, and the timing of the characterizing point is also put behind accordingly. Using such a difference in time at which the ink bubble collapses under different ink viscosities, it is possible to detect the viscosity in the individual channel 23 by causing the first energy generation element 14 to execute thickening detection driving.

Furthermore, if a driving pulse used for normal ejection is applied to the first energy generation element 14 to detect the viscosity in this thickening detection driving, the ink becomes ejected and lands on a paper surface or the like, so that the output image is affected thereby. Hence, it is preferable to apply a driving pulse having an energy for a bubble to form but low enough for the ink not to be ejected, or for a bubble to form and for the ink to be ejected but low enough not to land on the printout, unlike the normal driving pulse for ordinary ejection. In this manner, information on the viscosity in the individual channel 23 can be detected without affecting the printout, while suppressing ink consumption at the same time.

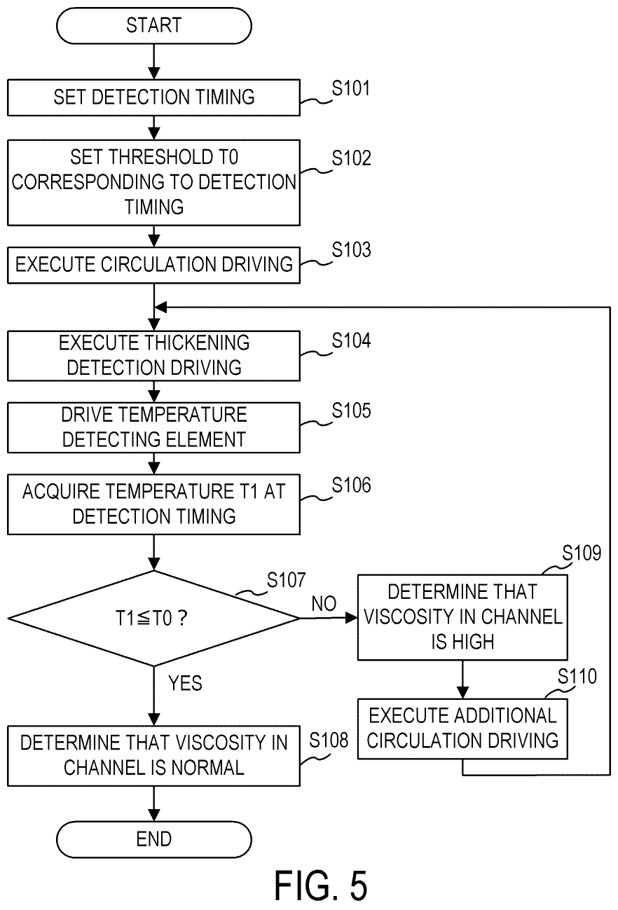

In the first embodiment, the liquid ejection device 50 is enabled to control the amount of ink circulated, on the basis of the viscosity information (temperature information) in the individual channels 23. The circulation amount control will now be explained with reference to FIG. 5. FIG. 5 is a flowchart of a circulation amount control according to the first embodiment.

To begin with, in step (hereinafter abbreviated as “S”) 101, by referring to thickening detection driving conditions of a pulse to be applied to the first energy generation element 14, the timing of viscosity detection is set to the characterizing point resulting from the normal in-channel viscosity, in advance. In other words, this detection timing is set to the timing at which the temperature of the individual channel 23 exhibits a sudden drop, as a result of the first energy generation element 14 being driven, with the normal ink viscosity in the individual channel 23. However, the detection timing is not limited thereto, and may be set as appropriate, within a range where the temperature of the individual channel 23 is on the decrease.

In S102, a temperature threshold TO corresponding to the detection timing is then set in advance, because a temperature difference appears at the characterizing point. It is possible to set the threshold TO by making predictions in advance, e.g., before shipment, or by creating the condition of normal in-channel viscosity, e.g., immediately after suctioning recovery, during the operation after the shipment.

In S103, the circulation driving then is executed by driving the second energy generation element 24. The second energy generation element 24 is driven under the control of the CPU 800 that is the control portion. As a result of driving the second energy generation element 24, a circulating flow 27 is formed in the individual channel 23, and ink is circulated.

In S104, the thickening detection driving is then executed by driving the first energy generation element 14. The amount of energy generated at this time by the first energy generation element 14 is smaller than that generated in ejection driving (ejection operation) for causing the ink to be ejected from the ejection opening 11. The first energy generation element 14 is driven under the control of the CPU 800 that is the control portion, in the same manner as the second energy generation element 24.

In S105, the temperature detection element 34 is then driven, and the temperature detection element 34 is caused to detect a temperature T1. In S106, the CPU 800 then acquires the temperature T1 at the time of the detection performed by the temperature detection element 34.

In S107, the CPU 800 then compares the temperature T1 acquired in S106 with the threshold TO set in S102, and determines whether the viscosity in the channel is normal, on the basis of the comparison result. Specifically, in S107, it is determined whether T1≤T0. If T1≤T0, that is, if the determination result is YES in S107, the processing sequence is advanced to S108 to determine that the viscosity in the channel is normal, and the circulation amount control is ended. By contrast, if T1>T0, that is, if the determination result is NO in S107, the processing sequence is advanced to S109, and it is determined that the viscosity in the channel is high.

If it is determined that the viscosity in the channel is high in S109, it is considered that the amount of circulation for resolving the thickened ink in the individual channel 23 is still insufficient, and the second energy generation element 24 is driven to execute additional circulation driving in S110. After the additional circulation driving is executed, the processing sequence goes back to S104, and the thickening detection driving is executed again. When the ink is circulated using the second energy generation element 24, a small amount of ink circulates by driving the second energy generation element 24 once, and the amount of circulation increases proportionally to the number of times the second energy generation element 24 is driven. Therefore, it is preferable to shift the processing sequence back to S104 after performing a fixed number of additional driving.

In the first embodiment, in S107, the acquired temperature T1 is compared with one threshold TO at the timing of the detection. This configuration is important from the viewpoint of determination accuracy, because a wide range can be ensured for setting the threshold. With a wide range ensured, it is possible to enhance the robustness against variations in the nozzle size and variations in the physical ink properties caused by temporal changes in the ink.

In the first embodiment, because the individual channels 23 are provided, and the first energy generation elements 14, the second energy generation elements 24, and the temperature detection elements 34 are provided correspondingly to the respective ejection openings 11, the amount of circulation can be controlled in units of one ejection opening 11. The condition of the thickened ink inside the individual channel 23 changes depending on factors such as the frequency at which the ejection opening 11 is used (the frequency of ink ejection). However, with the configuration of the first embodiment, it is possible to perform the circulation driving a manner suitable for each of the ejection openings 11, and to suppress the progress of the ink thickening caused by an excessive amount of ink circulation, for each of the individual channels 23.

In the first embodiment, in the comparison of the temperature with the threshold at the timing of detection, the temperature information detected by the temperature detection element 34 is used as it is, but the present invention is not limited to such a configuration. Because the characterizing point at which the temperature suddenly changes is used, for example, the first-order or the second-order derivative of the temporal change in the temperature may be calculated so as to emphasize the characterizing point, and the temperature at that point may then be compared with the threshold TO.

Furthermore, in the first embodiment, the determination is made by comparing the temperature at the timing of detection with the threshold. By contrast, it is also possible to determine whether the in-channel viscosity is normal or is high, by making use of the fact that the characterizing point appears at different timing depending on whether the viscosity in the channel is normal or high. Specifically, it is also possible to detect the time at which the characterizing point appears (e.g., as a length of time from the start of the circulation driving), and to determine whether the viscosity in the channel is normal or is still high on the basis of the time difference with respect to the time at which the characterizing point appears with the normal viscosity. In this case, if there is no time difference or the time difference is less than a predetermined threshold, it can be determined that the viscosity in the channel is normal. If there is a time difference or the time difference is equal to or more than the predetermined threshold, it can be determined that the viscosity in the channel is high.

Alternatively, it is also possible to determine whether the viscosity in the channel is normal or high by making use of a transition from a state having the high viscosity resolved (low viscosity) to a more viscous state (higher viscosity), as the circulation is continued. Specifically, it is possible to use the time difference between the time at which the characterizing point has appeared in the current thickening detection driving and the time at which the characterizing point had appeared during the previous thickening detection driving. In such a case, if there is no time difference or the time difference is less than a predetermined threshold, it is determined that ink thickening in the channel has been resolved, and the viscosity in the channel has gone back to normal, and, if there is any time difference or the time difference is equal to or more than the predetermined threshold, the ink thickening is currently being addressed and therefor the viscosity in the channel is still high. In the manner described above, it is possible to determine whether the viscosity in the channel is normal or high in any fashion, even without using the detection result (temperature information) as it is, as long as the detection result of the temperature detection element 34 is used.

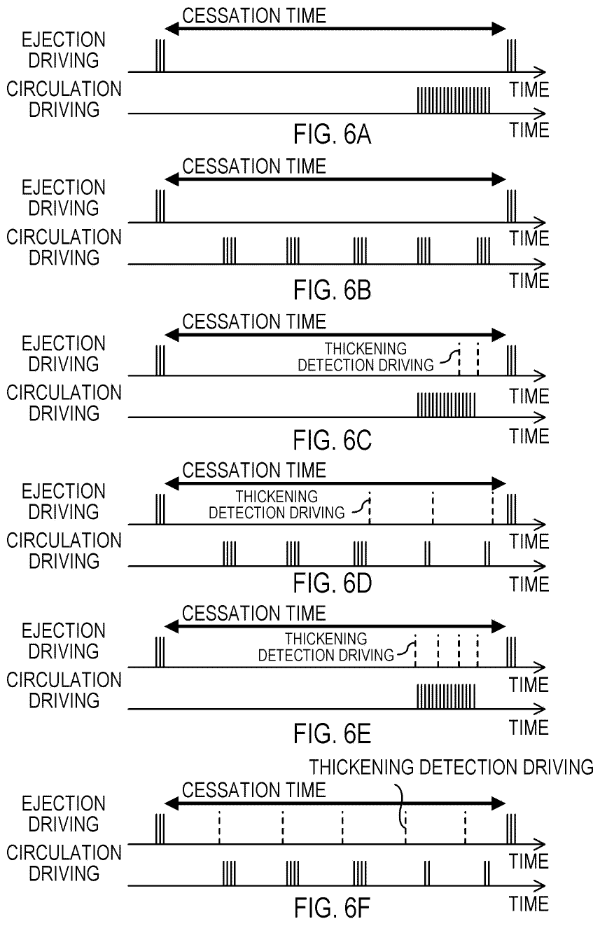

FIGS. 6A to 6F are charts for explaining a driving sequence including the ejection driving and the circulation driving. In FIGS. 6A to 6F, the horizontal axes represent time. Vertical lines (solid lines) plotted on these axes represent the timings at which the ejection driving and the circulation driving are executed, respectively. On the axes of the ejection driving, the timing of thickening detection driving is also plotted as vertical lines (dotted lines). In other words, the timings for driving the first energy generation element 14 are plotted on the axis corresponding to the ejection driving, and the timings for driving the second energy generation element 24 are plotted on the axis corresponding to the circulation driving.

FIGS. 6A and 6B are driving sequence charts to comparative examples. FIGS. 6C, 6D, 6E, and 6F are driving sequence charts according to the first embodiment.

FIG. 6A illustrates a driving sequence corresponding to circulation driving for driving to execute the circulating operation for a specific number of times at a specific frequency, while the ejection driving is in cessation but immediately before the end of such a cessation period (hereinafter, referred to as later-in-time packed driving). FIG. 6B illustrates a driving sequence corresponding to circulation driving for driving to execute the circulating operation at a specific frequency, intermittently at a constant time interval, while the ejection driving is in cessation (hereinafter, intermittent driving).

In the methods according to these comparative examples, because the timing at which and the number of times at which the circulation driving is executed need to be determined in advance, it is necessary to ensure a margin in the amount of circulation, in consideration of the ejection history and variations in the amount of circulation among the nozzles. If the amount of circulation is set in this manner, the amount of circulation may exceed the amount necessary for resolving the ink thickening. As a result, ink thickening resultant of an excessive amount of circulation, which is unique to the microcirculation, may proceed in the individual channel.

By contrast, with the configuration according to the first embodiment, by executing the thickening detection driving, the timing at which and the number of times by which the circulation driving is executed can be determined on the basis of the detection result or the determination result. A driving sequence for executing the thickening detection driving, and then executing the circulation driving on the basis of the result of the thickening detection driving will now be explained.

FIG. 6C illustrates an example in which the thickening detection driving is executed in the later-in-time packed driving sequence. In this example, the thickening detection driving is executed after the circulation driving is executed a predetermined number of times, and the determination result of the thickening detection driving is fed back to the circulation driving. If it is determined that the ink thickening has been resolved in the determination, it is possible to control to end the circulation driving so that unnecessary circulation driving is not executed. By contrast, if it is determined that the ink thickening has not been resolved sufficiently in the determination, the ink thickening in the channel can be resolved by executing additional circulation driving so as to increase the amount of circulation. FIG. 6C illustrates an example in which it is determined that the ink thickening has not been sufficiently resolved in the first run of the thickening detection driving, so that additional circulation driving is executed a plurality of times, and it is determined that the ink thickening has been resolved in the second run of the thickening detection driving. Note that parameters of the circulation amount control can be adjusted by reducing the number of times the second energy generation element 24 is driven.

FIG. 6D illustrates an example in which the thickening detection driving is executed in the intermittent driving sequence. In this example, the thickening detection driving is executed after the circulation driving is repeated intermittently, and the determination result is fed back to the circulation driving. Even with this, it is possible to determine whether the subsequent circulation driving is to be executed for how many times, on the basis of the determination result. Examples of the parameters for controlling the amount of circulation include the number of times the second energy generation element 24 is driven, the time interval between executions of the circulation driving, and whether the subsequent circulation driving in the intermittent circulation driving is to be executed. FIG. 6D illustrates an example of a driving sequence that executes the circulation driving four times, intermittently, but with the number of executions decreased to twice after the first thickening detection driving, on the basis of the determination result.

FIG. 6E illustrates an example in which the thickening detection driving is executed prior to the circulation driving, in the later-in-time packed driving sequence. By selecting such a sequence, the circulation amount control can be executed while detecting ink thickening being resolved, by keeping detecting the ink thickening prior to a circulation and executing the circulation driving on the basis of the ink thickening detection result.

FIG. 6F illustrates an example in which the thickening detection driving is executed prior to the first run of circulation driving, in the intermittent drive sequence. Even with such a sequence, it is possible to detect the condition of the ink thickening in the channel, and to control the circulation amount on the basis of the condition of the ink thickening.

As described above, with the configuration according to the first embodiment, thickening of the ink in the channel can be detected on the basis of the detection result of the temperature detection element 34, by determining whether the temperature drop has occurred, in the process of temperature decrease, at the detection timing corresponding to the characterizing point in the temperature change with the normal viscosity. By giving the feedback of the detection result to the circulation driving, the drive of the second energy generation element 24 is controlled to perform the circulation driving in such a manner that the circulation amount does not become excessive. In this manner, it is possible to suppress the circulation amount in each of the ejection openings 11 (nozzles), and to suppress the progress of thickening in the individual channel 23 accompanying the excessive amount of circulation. Because it is possible to maximize the time with the effect of thickening suppressed, it is possible to reduce the maintenance time required and the amount of waste ink accrued by suctioning recovery operation or the like for addressing the ink thickening.

Furthermore, in the configuration according to the first embodiment, because the temperature detection element 34 is provided immediately below the first energy generation element 14, it is also possible to execute an ejection detection for detecting whether ink has been ejected appropriately, using the temperature detection element 34. This operation uses the fact that the time at which the characterizing point associated with the bubble collapse appears at different timing between when the ejection is normal and when there is no ejection due to ejection failure. Therefore, such an ejection detection and circulation amount control can be performed using the same temperature detection element.

Although, in the first embodiment, the temperature detection element 34 is provided immediately below the first energy generation element 14, the present invention is not limited to such a configuration. Because the temperature detection element 34 is installed for the purpose of detecting a temperature change near the first energy generation element 14 when the first energy generation element 14 is driven for the thickening detection, the temperature detection element 34 may be disposed at any position corresponding to the first energy generation element 14, such as the position immediately above or near the first energy generation element 14. Furthermore, it is also possible to provide an element having both of the energy generating functions of the first energy generation element 14 and the temperature detecting function of the temperature detection element 34, without providing the independent temperature detection element 34.

### Second Embodiment

A second embodiment of the present disclosure will now be explained. The second embodiment is different from the first embodiment in the position where the temperature detection element 34 is disposed. In the following second embodiment, only the elements that are different from those in the first embodiment will be explained. In the configuration according to the second embodiment, the elements that are the same as those in the first embodiment will be given the same reference numerals, and descriptions thereof will be omitted.

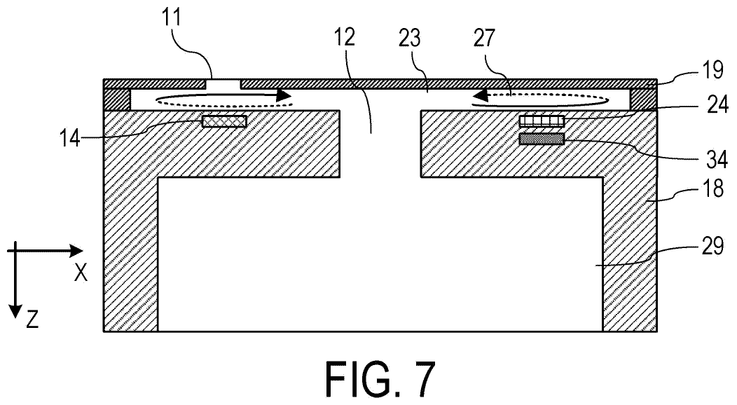

FIG. 7 is a schematic for explaining a configuration near an ejection opening 11 on the liquid ejection chip 3 according to the second embodiment, and is a cross-sectional view taken along line A-A in FIG. 4A. The plan view of the liquid ejection chip 3 in a view along the Z direction and the schematic diagram of the enlargement of the portion corresponding to the individual channel in the second embodiment are the same as those in FIGS. 4A and 4C according to the first embodiment.

In the first embodiment, thermoelectric transducers are used as the first energy generation element 14 and the second energy generation element 24. It is also possible to use another type of element such as a piezoelectric element as the first energy generation element 14.

In the second embodiment, the temperature detection element 34 is disposed at a position overlapping with the second energy generation element 24, in a view along the Z direction. The temperature detection element 34 is positioned immediately below the second energy generation element 24, as illustrated in FIG. 7, that is, on the side farther away from the individual channel 23, than the second energy generation element 24. Note that the temperature detection element 34 does not need to be disposed immediately below the second energy generation element 24, and may be disposed at any position corresponding to the second energy generation element 24.

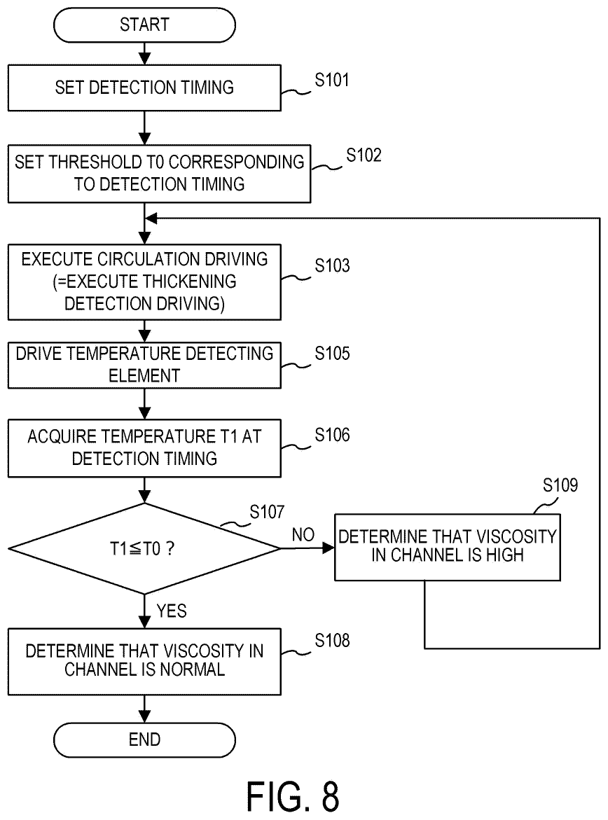

FIG. 8 is a flow chart illustrating circulation amount control according to the second embodiment. Because the circulation amount control according to the second embodiment has many common points with the circulation amount control according to the first embodiment, only the differences with respect to the first embodiment will be described below.

To begin with, in S101, by referring to the thickening detection driving conditions of a pulse to be applied to the second energy generation element 24, the timing of viscosity detection is set to the characterizing point resulting from the normal in-channel viscosity, in advance. In other words, this detection timing is set to the timing at which the temperature of the individual channel 23 exhibits a sudden drop, as a result of the second energy generation element 24 being driven, with the normal ink viscosity in the individual channel 23. However, the detection timing is not limited thereto, and may be set as appropriate, within a range where the temperature of the individual channel 23 is on the decrease.

As illustrated in FIG. 8, in the second embodiment, the thickening detection driving performed in S104 of the first embodiment is omitted. This is because when the circulation driving is executed in S103, the second energy generation element 24 is driven and the thickening detection driving is also performed. Therefore, after the circulation driving and the thickening detection driving are performed in S103, the processing sequence proceeds to S105, where the temperature is output from the temperature detection element 34.

Also, in the second embodiment, the sequence of executing additional circulation driving in S110, after it is determined that the viscosity in the channel is high in S109, is omitted. This is because the circulation driving is executed with the execution of the thickening detection driving in S103. Accordingly, after it is determined that the viscosity in the channel is high in S109, the processing sequence goes back to S103, and the circulation driving and the thickening detection driving are executed simultaneously.

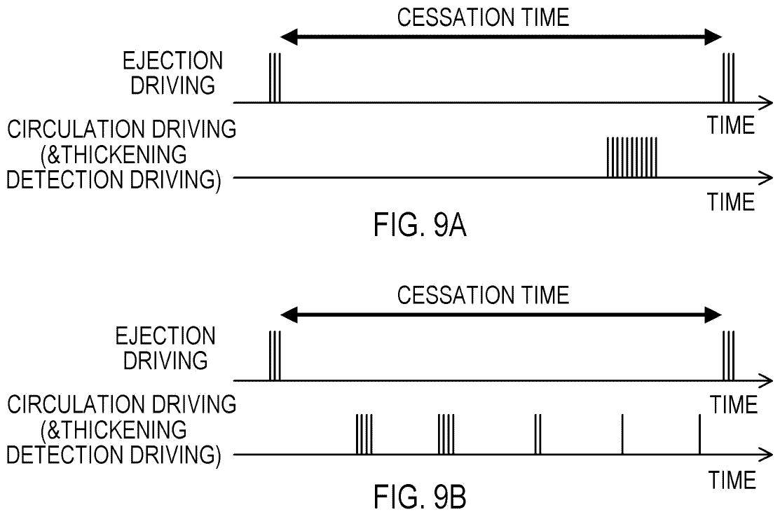

FIGS. 9A and 9B are schematics for explaining a driving sequence including the ejection driving and the circulation driving according to the second embodiment. In FIGS. 9A and 9B, the horizontal axes represent the time, and the vertical lines (solid lines) plotted to the axes represent the timings at which the ejection driving and the circulation driving are executed, respectively. In the second embodiment, the timing for executing the circulation driving is the same as the driving timing at which the thickening detection driving is executed.

FIG. 9A illustrates an example in which the thickening detection driving is executed, in the later-in-time packed driving sequence. In this example, the circulation driving is executed immediately before the ejection driving is executed. In the second embodiment, the thickening detection driving is executed simultaneously with the circulation driving. By then determining the number of times the subsequent circulation driving and thickening detection driving are executed simultaneously or the like, on the basis of the determination result of the thickening detection driving, it is possible to adjust the amount of circulation.

FIG. 9B illustrates an example in which the thickening detection driving is executed in the intermittent driving sequence. In this example, a set of one or more runs of circulation driving is executed intermittently. FIG. 9B illustrates an example in which the number of times the circulation driving is executed is decreased incrementally, from four times to twice, and from twice to once.

In the configuration according to the second embodiment, too, the circulation amount can be controlled by executing the thickening detection driving, in the same manner as in the first embodiment. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23.

Furthermore, by disposing the temperature detection element 34 at a position corresponding to the second energy generation element 24, the following advantages can be achieved. First, thickening detection driving and the circulation driving can be executed at the same time by driving the second energy generation element 24. Therefore, it is possible to detect ink thickening at every circulation driving, so that fine circulation amount control can be performed. Furthermore, because ink is not ejected in the circulation driving, viscosity detection can be performed by applying a driving pulse used for normal circulation, and detection sensitivity is also improved as well.

### Third Embodiment

A third embodiment of the present disclosure will now be explained. The third embodiment is different from the first embodiment in the shape of the individual channel 23. In the following third embodiment, only the elements that are different from those in the first embodiment will be explained. In the configuration according to the third embodiment, the elements that are the same as those in the first embodiment will be given the same reference numerals, and descriptions thereof will be omitted.

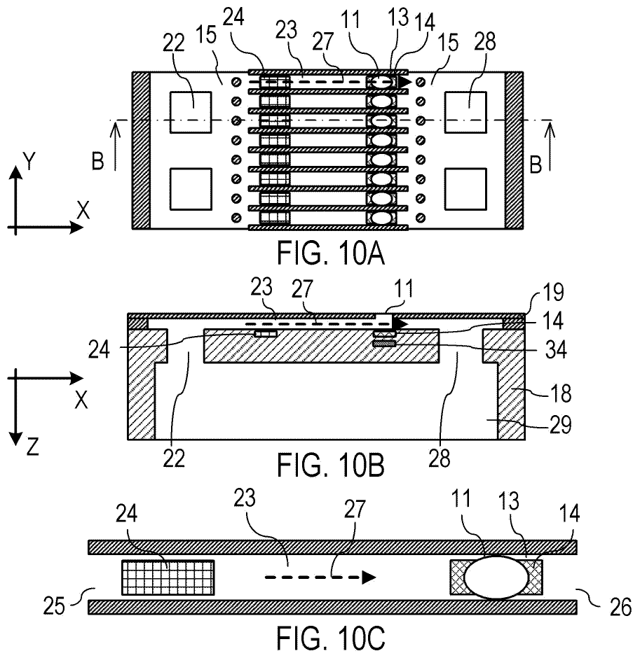

FIGS. 10A to 10C are schematics for explaining the channel configuration of the liquid ejection chip 3 according to the third embodiment. FIG. 10A is a schematic for explaining a configuration near the ejection openings 11 on the liquid ejection chip 3, and is a schematic diagram illustrating a positional relationship among main components, in a view of the liquid ejection chip 3 in the Z direction. FIG. 10A illustrates only one row of a plurality of ejection openings 11 that are aligned in the Y direction. FIG. 10B is a cross-sectional view taken along B-B in FIG. 10A. FIG. 10C is a schematic diagram illustrating an enlargement of a portion corresponding to an individual channel in FIG. 10A. In FIG. 10A, to indicate the positional relationship of the main components, the first energy generation element 14 and the second energy generation element 24 are given the same respective hatchings as those in FIG. 10B, and the ejection openings 11 are indicated by solid lines.

The individual channels 23 according to the third embodiment have a linear shape, as illustrated in FIG. 10C. Hereinafter, such a channel shape will be referred to as a straight shape. The straight individual channel 23 is provided linearly in a manner extending from the inlet 25 to the outlet 26 in the X direction. That is, the inlet 25 is disposed on one end of the individual channel 23 in the X direction, and the outlet 26 is disposed on the other end of the individual channel 23 in the X direction.

The first energy generation element 14 is disposed at a position overlapping with the ejection opening 11 and the individual channel 23 (pressure chamber 13) in a view along the Z direction, and closer to the outlet 26 in the X direction. The second energy generation element 24 is disposed at a position overlapping with the individual channel 23 in a view along the Z direction, and on the side nearer to the inlet 25 in the X direction. The temperature detection element 34 is disposed at a position overlapping with the first energy generation element 14 in a view along the Z direction. By driving the second energy generation element 24, a circulating flow 27 is generated inside the individual channel 23 in the direction traveling from the inlet 25 to the outlet 26 (rightward in FIG. 10A), and the ink inside the individual channel 23 is circulated.

The substrate 18 is provided with a supply opening 22 on the upstream side of the individual channel 23 in the liquid circulation direction, and is provided with a recovery opening 28 on the downstream side. The supply opening 22 and the recovery opening 28 both communicate with the common channel 15. The substrate 18 further includes a common liquid chamber 29 that communicates with the supply opening 22 and the recovery opening 28, and into which the ink supplied from the ink tank 54 is passed. Accordingly, by driving the second energy generation element 24, the ink is passed in such a manner that ink circulates through the common liquid chamber 29, the supply opening 22, the common channel 15, the individual channel 23, the common channel 15, the recovery opening 28, and the common liquid chamber 29, in the order listed herein. By allowing the ink to circulate in the manner described above, it is possible to achieve the effect of resolving the ink thickening, in the same manner as in the first and the second embodiments.

In the straight channel, because the outlet 26 and the inlet 25 of the individual channel 23 are at positions separated from each other, the thickened ink having evaporated at the ejection opening portion is less likely to flow into the individual channel 23 again, compared with a U-shape channel. However, the configuration according to the third embodiment is no different in that the thickened ink evaporated at the ejection opening portion remains in the common liquid chamber 29 that is connected to the individual channel 23. Therefore, when the ink is circulated excessively, the progress of the ink thickening in the entire channel including the individual channel 23 and the common liquid chamber 29 still needs to be addressed. Accordingly, in order to suppress the progress of ink thickening associated with the circulation in the channel, it is preferable to control the circulation amount so as not to circulate any ink more than necessary.

In the configuration according to the third embodiment, too, it is possible to control the circulation amount by executing the thickening detection driving, using the same method as that according to the first embodiment. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23.

The advantage of using a straight individual channel 23 is that the inlet 25 and the outlet 26 for the circulation are positioned apart from each other, so that the thickened ink evaporated at the ejection opening portion is less likely to re-enter the individual channel 23. Therefore, it is possible to focus only on addressing the ink thickening associated with an excessive circulation in the common liquid chamber 29.

### Fourth Embodiment

A fourth embodiment of the present disclosure will now be explained. The fourth embodiment is different from the third embodiment in the position where the temperature detection element 34 is disposed. In the following fourth embodiment, only the elements that are different from those in the third embodiment will be explained. In the configuration according to the fourth embodiment, the elements that are the same as those in the third embodiment will be given the same reference numerals, and descriptions thereof will be omitted.

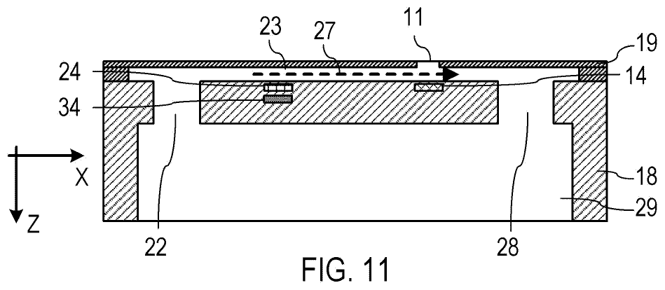

FIG. 11 is a schematic for explaining a configuration near an ejection opening 11 in the liquid ejection chip 3 according to the fourth embodiment, and is a cross-sectional view taken along line B-B in FIG. 10A. The plan view of the liquid ejection chip 3 according to the fourth embodiment along the Z direction, and the schematic diagram of an enlargement of the portion corresponding to the individual channel are the same as those in FIGS. 10A and 10C according to the third embodiment.

In the fourth embodiment, the temperature detection element 34 is disposed at a position overlapping with the second energy generation element 24, in a view along the Z direction. The temperature detection element 34 is positioned immediately below the second energy generation element 24, as illustrated in FIG. 11, that is, on the side farther away from the individual channel 23, than the second energy generation element 24. Note that the temperature detection element 34 does not need to be disposed immediately below the second energy generation element 24, and may be disposed at any position corresponding to the second energy generation element 24.

In the configuration according to the fourth embodiment, too, the circulation amount can be controlled by executing the thickening detection driving, using the same method as that used in the second embodiment. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23. Furthermore, because the individual channels 23 are straight, the same advantages as those in the third embodiment can be achieved.

### Fifth Embodiment

A fifth embodiment of the present disclosure will now be explained. The fifth embodiment is different from the first embodiment and the third embodiment in the shape of the individual channel 23. In the following fifth embodiment, only the elements that are different from those in the third embodiment will be explained. In the configuration according to the fifth embodiment, the elements that are the same as those in the third embodiment will be given the same reference numerals, and descriptions thereof will be omitted.

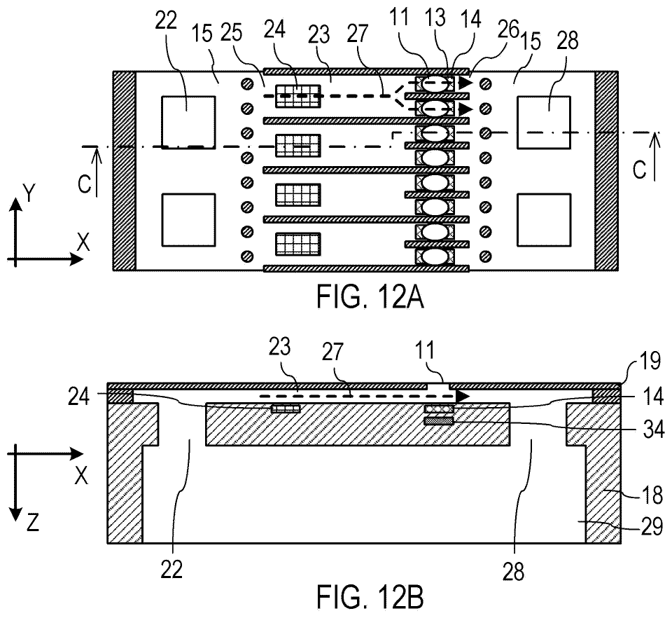

FIGS. 12A and 12B are schematics for explaining the channel configuration of the liquid ejection chip 3 according to the fifth embodiment. FIG. 12A is a schematic for explaining a configuration near the ejection openings 11 of the liquid ejection chip 3, and is a schematic diagram illustrating a positional relationship among main components, in a view of the liquid ejection chip 3 in the Z direction. FIG. 12A illustrates only one row of a plurality of ejection openings 11 that are aligned in the Y direction. FIG. 12B is a cross-sectional view taken along C-C in FIG. 12A. In FIG. 12A, to indicate the positional relationship of the main components, the first energy generation element 14 and the second energy generation element 24 are given the same respective hatchings as those in FIG. 12B, and the ejection openings 11 are indicated by solid lines.

The individual channel 23 according to the fifth embodiment is a straight channel, and is be branched to two, on the way from the inlet 25 to the outlet 26. The individual channel 23 has one inlet 25 positioned on one end in the X direction and two outlets 26 positioned on the other end in the X direction. Two pressure chambers 13 (ejection openings 11) are provided in a manner communicating with one individual channel 23. The substrate 18 is provided with two first energy generation elements 14 and one second energy generation element 24, correspondingly to one individual channel 23.

The first energy generation elements 14 are provided correspondingly to the respective branched channels, and are disposed at positions overlapping with the respective ejection openings 11 and individual channels 23 (pressure chambers 13) in a view along the Z direction, and on the side nearer to the outlet 26 in the X direction. The second energy generation element 24 is provided to the portion not branched into two, and is disposed at a position overlapping with the individual channel 23 in a view along the Z direction, and on the side nearer to the inlet 25 in the X direction. By driving the second energy generation element 24, a circulating flow 27 is generated in the individual channel 23 in the direction from the inlet 25 to the outlet 26 (rightward in FIG. 12A), and the ink inside the individual channel 23 is circulated.

In the fifth embodiment, one temperature detection element 34 is provided correspondingly to one individual channel 23. The temperature detection element 34 is disposed at a position overlapping with one of the first energy generation elements 14 in a view along the Z direction. That is, the temperature detection element 34 is not provided correspondingly to each one of the first energy generation elements 14.

In the configuration according to the fifth embodiment, too, the circulation amount can be controlled by executing the thickening detection driving, using the same method as that according to the first embodiment. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23.

The advantage in providing the two ejection openings 11 and the two first energy generation elements 14 correspondingly to one individual channel 23 is that the circulation amount can be controlled by detecting the ink thickening on the basis of the detection result of one temperature detection element 34 corresponding to the two ejection openings 11. Furthermore, it is possible to reduce the number of the second energy generation elements 24 and the temperature detection elements 34 with respect to the number of the first energy generation elements 14. In such a configuration, however, it is also possible to provide the temperature detection elements 34 correspondingly to the respective first energy generation elements 14.

### Sixth Embodiment

A sixth embodiment of the present disclosure will now be explained. The sixth embodiment is different from the fifth embodiment in the position where the temperature detection element 34 is disposed. In the following sixth embodiment, only the elements that are different from those in the fifth embodiment will be explained. In the configuration according to the sixth embodiment, the elements that are the same as those in the fifth embodiment will be given the same reference numerals, and descriptions thereof will be omitted.

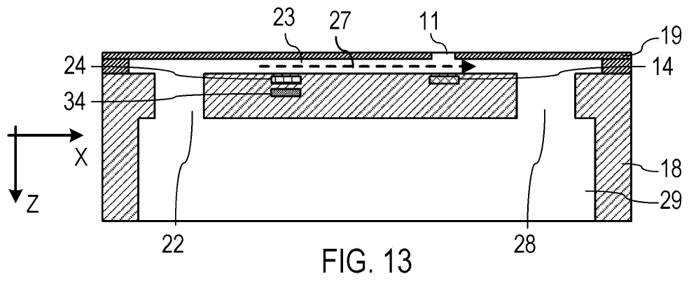

FIG. 13 is a schematic for explaining a configuration near an ejection opening 11 in the liquid ejection chip 3 according to the sixth embodiment, and is a cross-sectional view taken along line C-C in FIG. 12A. The plan view of the liquid ejection chip 3 according to the sixth embodiment along the Z direction and the schematic diagram of the enlargement of the portion corresponding to the individual channel are the same as those in FIGS. 12A and 12C according to the fifth embodiment.

In the sixth embodiment, the temperature detection element 34 is disposed at a position overlapping with the second energy generation element 24, in a view along the Z direction. The temperature detection element 34 is positioned immediately below the second energy generation element 24, as illustrated in FIG. 13, that is, on the side farther away from the individual channel 23, than the second energy generation element 24. Note that the temperature detection element 34 does not need to be disposed immediately below the second energy generation element 24, and may be disposed at any position corresponding to the second energy generation element 24.

That is, the configuration according to the sixth embodiment is different from the configuration according to the fourth embodiment in that one second energy generation element 24 corresponds (connects) to two first energy generation elements 14 in one individual channel 23.

In the configuration according to the sixth embodiment, too, the circulation amount can be controlled by executing the thickening detection driving, using the same method as that according to the second embodiment. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23. Furthermore, because the two ejection openings 11 and the two first energy generation elements 14 can be provided correspondingly to one individual channel 23, it is possible to achieve the same advantageous effects as those in the fifth embodiment.

### Seventh Embodiment

A seventh embodiment of the present disclosure will now be explained. The seventh embodiment is different from the first embodiment and the second embodiment in the method of controlling the amount of circulation. In the following seventh embodiment, only the elements that are different from those in the second embodiment will be explained. In the configuration according to the seventh embodiment, the elements that are the same as those in the second embodiment will be given the same reference numerals, and descriptions thereof will be omitted.

The seventh embodiment is different from each of the embodiments described above in that the circulation amount control is completed within the liquid ejection head 1. In the seventh embodiment, the temperature detection element 34 is provided at a position corresponding to the second energy generation element 24, and a control portion including a CPU or the like is provided to the liquid ejection head 1. In other words, the liquid ejection chip 3 has the same configuration of as that according to any one of the second, fourth, and sixth embodiments described above.

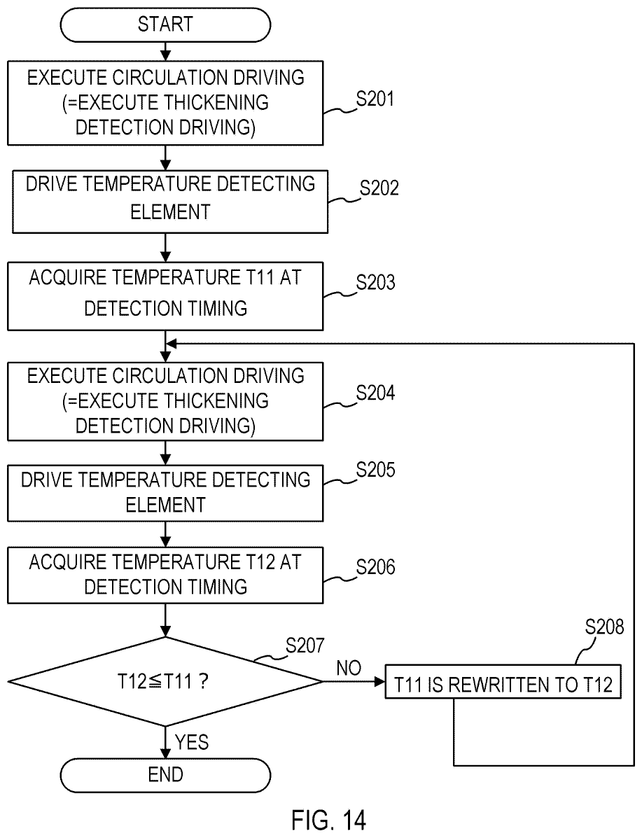

In the seventh embodiment, the liquid ejection head 1 is enabled to control the amount of ink circulation based on viscosity information (temperature information) in the individual channels 23. FIG. 14 is a flowchart of circulation amount control according to a seventh embodiment.

First, in S201, the second energy generation element 24 is driven to execute the circulation driving. Because the temperature detection element 34 is disposed correspondingly to the second energy generation element 24, it is possible to execute the thickening detection driving simultaneously with the circulation driving.

In S202, the temperature detection element 34 is then driven, and the temperature detection element 34 is caused to detect a temperature T11. In S203, the control portion in the liquid ejection head 1 then acquires the temperature T11 at the timing of the detection performed by the temperature detection element 34.

The second energy generation element 24 is then driven in S204, to execute the circulation driving and the thickening detection driving again. The temperature detection element 34 is then driven in S205, and the temperature detection element 34 is caused to detect the temperature T12. In S206, the control portion in the liquid ejection head 1 then acquires the temperature T12 at the timing of the detection performed by the temperature detection element 34.

In S207, the control portion then acquires the temperature T11 obtained in S203 and the temperature T12 obtained in S206, and determines whether the relation T12≤T11 is satisfied. If T12≤T11, that is, if the determination result is YES in S207, it is determined that the viscosity in the channel is normal and the circulation amount control is ended as it is. By contrast, if T12>T11, that is, if the determination result is NO in S207, it is determined that the viscosity in the channel is high, and the process sequence is shifted to S208.

In S208, T11 is rewritten to T12, that is, the value of the temperature T11 is rewritten by the value of the temperature T12. The process sequence is then shifted to S204, where the circulation driving is executed again.

In the manner described above, in the seventh embodiment, the detected temperature (temperature T11) during the circulation driving in S201 to S203 is compared with the detected temperature (temperature T12) during the circulation driving at S204 to S206, in S207. Furthermore, if it is determined that T12>T11 in the S207, the temperature detected in the first run of the circulation driving in S204 to S206 is compared with the detected temperature detected in the second run of the circulation driving of S204 to S206, in the S207. In other words, in the seventh embodiment, the second energy generation element 24 is driven, and the circulation driving is executed, on the basis of the detected temperatures detected by the temperature detection element 34 before and after the second energy generation element 24 is driven. By comparing the detected temperatures before and after the circulation in the manner described above, it is possible to determine whether to continue or end the circulation and to control the amount of circulation. Such temperature comparison can be executed by incorporating a comparison circuit into the liquid ejection head 1.

As described above, in the configuration according to the seventh embodiment, too, the circulation amount can be controlled by executing the thickening detection driving. Therefore, by detecting the thickened condition of the ink in the channel on the basis of the detection result of the temperature detection element 34, and feeding back the detection result to the circulation driving, it is possible to execute the circulation driving by driving the second energy generation element 24 in such a manner that the circulation amount does not become excessive. With this, because the amount of circulation in each of the nozzles can be suppressed, it is possible to suppress the progress of ink thickening associated with the excessive amount of circulation, in the individual channel 23.

The advantage achieved by the configuration in which the circulation control is completed within the liquid ejection head 1 is that the circulation amount control can be performed by the liquid ejection head 1 alone without causing a load associated with data transfer between the liquid ejection head 1 and the liquid ejection device 50.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-135219, filed Aug. 14, 2024, which is hereby incorporated by reference herein in its entirety.

What is claimed is:

1. A liquid ejection device comprising:
a channel forming portion including an ejection opening through which a liquid is ejected, a pressure chamber communicating with the ejection opening, and an individual channel communicating with the pressure chamber;
a first energy generation element provided at a position corresponding to the pressure chamber of the channel forming portion, and generates energy for ejecting the liquid through the ejection opening;
a second energy generation element provided at a position corresponding to the individual channel of the channel forming portion, and generates energy for passing the liquid through the individual channel;
a temperature detection portion configured to detect a temperature, and is disposed at a position corresponding to the first energy generation element or the second energy generation element; and
a control portion configured to control driving of the second energy generation element based on a detection result of the temperature detection portion.

2. The liquid ejection device according to claim 1,
wherein the control portion controls driving of the second energy generation element based on a comparison result of comparing a detection temperature detected by the temperature detection portion with a predetermined threshold.

3. The liquid ejection device according to claim 1,
wherein the control portion controls driving of the second energy generation element based on a time at which the detection temperature detected by the temperature detection portion exhibits a sudden change.

4. The liquid ejection device according to claim 1,
wherein the control portion controls driving of the second energy generation element based on respective detected temperatures detected by the temperature detection portion before and after the second energy generation element is driven.

5. The liquid ejection device according to claim 1,
wherein the first energy generation element is disposed at a position overlapping with the ejection opening in a first direction, and the temperature detection portion is disposed at a position overlapping with the first energy generation element in the first direction.

6. The liquid ejection device according to claim 5,
wherein the control portion is capable of performing a thickening detection driving for detecting thickening of the liquid in the individual channel by driving the first energy generation element, and controls driving of the first energy generation element so that an amount of energy generated by the first energy generation element during the thickening detection driving is less than an amount of energy generated during ejection driving for ejecting the liquid from the ejection opening.

7. The liquid ejection device according to claim 5,
wherein the temperature detection portion detects a temperature in the individual channel at a timing at which a temperature in the individual channel exhibits a sudden drop as the first energy generation element is driven while viscosity of the liquid in the individual channel is normal.

8. The liquid ejection device according to claim 1,
wherein the first energy generation element is disposed at a position overlapping with the ejection opening in a first direction, and the temperature detection portion is disposed at a position overlapping with the second energy generation element in the first direction.

9. The liquid ejection device according to claim 8,
wherein the temperature detection portion detects a temperature in the individual channel at a timing at which a temperature in the individual channel exhibits a sudden drop as the second energy generation element is driven while viscosity of the liquid in the individual channel is normal.

10. The liquid ejection device according to claim 1,
wherein the first energy generation element and the second energy generation element are provided at positions corresponding to the individual channel, and the individual channel has a U shape provided from a position corresponding to the second energy generation element to a position corresponding to the first energy generation element.

11. The liquid ejection device according to claim 10,
wherein the first energy generation element and the second energy generation element are disposed at positions overlapping with the individual channel in a first direction, and an inlet and an outlet of the individual channel are adjacent to each other in a second direction intersecting with the first direction.

12. The liquid ejection device according to claim 1,
wherein the first energy generation element and the second energy generation element are provided at positions corresponding to the individual channel, and the individual channel has a linear shape extending from a position corresponding to the second energy generation element to a position corresponding to the first energy generation element.

13. The liquid ejection device according to claim 1,
wherein the first energy generation element and the second energy generation element are provided at positions corresponding to the individual channel, and the individual channel is branched into two from a position corresponding to the second energy generation element to a position corresponding to the first energy generation element.

14. The liquid ejection device according to claim 1,
wherein the channel forming portion includes a plate member having the ejection opening and forming a portion of an inner wall of the individual channel, and a substrate connected to the plate member and forming a portion of an inner wall of the individual channel.

15. The liquid ejection device according to claim 1, further comprising:
a liquid ejection head that has the channel forming portion, and is provided with the first energy generation element, the second energy generation element, and the temperature detection portion; and
a conveying portion that conveys a recording medium at a position facing the ejection opening.

16. The liquid ejection device according to claim 1,
wherein at least one of the first energy generation element and the second energy generation element is a thermoelectric transducer.

17. A liquid ejection head comprising:
a channel forming portion including an ejection opening through which a liquid is ejected, a pressure chamber communicating with the ejection opening, and an individual channel communicating with the pressure chamber;
a first energy generation element provided at a position corresponding to the pressure chamber of the channel forming portion, and generates energy for ejecting the liquid through the ejection opening;
a second energy generation element provided at a position corresponding to the individual channel of the channel forming portion, and generates energy for passing the liquid through the individual channel;
a temperature detection portion configured to detect a temperature, and is disposed at a position corresponding to the first energy generation element or the second energy generation element; and
a control portion configured to control driving of the second energy generation element based on a detection result of the temperature detection portion.
